(19) United States
(12) Patent Application Publication
(10) Pub. No.: US 2011/0100049 A1
(43) Pub. Date: May 5, 2011

(54) COUNTERMOUNT, TAPPING APPARATUS AND METHOD FOR REGULATING THE TEMPERATURE OF BEVERAGE

(75) Inventor: Bart Jan Bax, Blaricum (NL)

(73) Assignee: HEINEKEN SUPPLY CHAIN B.V., 1017 ZD Amsterdam (NL)

(21) Appl. No.: 12/993,654

(22) PCT Filed: May 22, 2009
(86) PCT No.: PCT/NL2009/050281

§ 371 Date: Dec. 29, 2010

(30) Foreign Application Priority Data
May 22, 2008 (NL) 2001612

(51) Int. Cl. F25B 21/02; B67D 7/80; F25D 3/00

(52) U.S. Cl. 62/396; 222/146.6; 62/3.64; 62/79

(57) ABSTRACT

A countermount, provided with a jacket (13) and a passage (16), wherein the jacket is provided with a supply (14) and a discharge (15) for a cooling fluid and the passage extends between an inlet and a tap, wherein within the passage a beverage line is provided which extends at least between the inlet (17) and the tap (7), wherein between at least a part of a wall of the passage and the beverage line, a temperature regulating space (24) and/or a temperature regulating element (80) is provided.

The invention relates to a countermount. The invention further relates to a tapping apparatus, provided with a countermount. In particular, the invention concerns a cooled countermount and tapping apparatus provided with a cooled countermount.

WO2006/103566 describes a tapping apparatus for beverage, provided with a cooled countermount. The tapping apparatus comprises a cooling space on which the countermount is mounted and in which a beverage container such as a keg can be set up and cooled with the aid of air which is cooled by a first heat exchanger and which is forced through the cooling space by a fan. The countermount is cooled using a cooling liquid which is introduced via an inlet into a chamber in the countermount and is discharged from the chamber again via an outlet. The cooling liquid is cooled in a second heat exchanger, which is integrated with the first heat exchanger in one block. A beverage line extends from the container to a tap and is in thermal contact with the cooling liquid in that the beverage line is pressed against a wall of the chamber. During use, the air to be cooled and the cooling liquid exchange heat with the same cooling element.

In this known tapping apparatus, the beverage line is pressed against a wall of the chamber that is cooled by the cooling liquid, so that direct thermal contact is obtained. The countermount is separated from the first cooling medium. The temperature of the countermount will then have to be brought to and kept approximately at the desired tap temperature of the beverage by the cooling liquid, in order to be able to dispense the beverage with that desired temperature and to prevent freezing of the beverage in the beverage line. Accordingly, the temperature of the cooling liquid needs to be regulated within narrow limits and moreover needs to be kept relatively high.

An object of the present invention is to provide a countermount and tapping apparatus, wherein the temperature of the countermount can be regulated, substantially independently of the temperature of the beverage that is present in a beverage line in the countermount.

Another object of the present invention is to provide a countermount whose temperature can be set, such that the outer side thereof is colder than the desired temperature of the beverage to be dispensed.

A further object of the present invention is to provide a countermount on which, at the outside, ice can be formed, also in a relatively warm space, while the beverage that is present in a beverage line in the countermount remains liquid.

Another object of the invention is to provide a method for regulating the temperature of beverage in a beverage line that extends through a countermount.

These and/or other objects, which have been mentioned in random order, can be achieved with a countermount, tapping apparatus and/or method according to the invention.

In a first aspect, a countermount according to the description is characterized in that it is provided with a jacket and a passage, wherein the jacket is provided with a supply and a discharge for a cooling fluid. The passage extends between an inlet and a tap. Within the passage, a beverage line is provided which extends at least between the inlet and the tap. Between at least a part of a wall of the passage and the beverage line, a temperature regulating space and/or a temperature regulating element is provided.

In another aspect, a tapping apparatus according to the description is characterized in that it is provided with a cooling space and a countermount. Through the countermount extends a beverage line, from the cooling space at least up to a tap near an end of the countermount remote from the cooling space. Within the countermount a space extends along at least a part of the beverage line, which space is in fluid communication or can be brought into fluid communication with an inner space of the cooling space, wherein the countermount is provided with a supply and a discharge for a cooling medium for cooling at least a part of an outer side of the countermount.

In a further aspect, a method according to the invention is characterized in that around at least a part of the beverage line within the countermount a fluid flow is effected which is supplied from the environment of the countermount and/or from a cooling space. At least a part of the countermount is cooled with a cooling medium other than the fluid flow, in particular to a temperature lower than that of the fluid flow.

To clarify the invention, exemplary embodiments of a countermount, tapping apparatus and method and parts suitable therefor will be described with reference to the drawing. In the drawing:

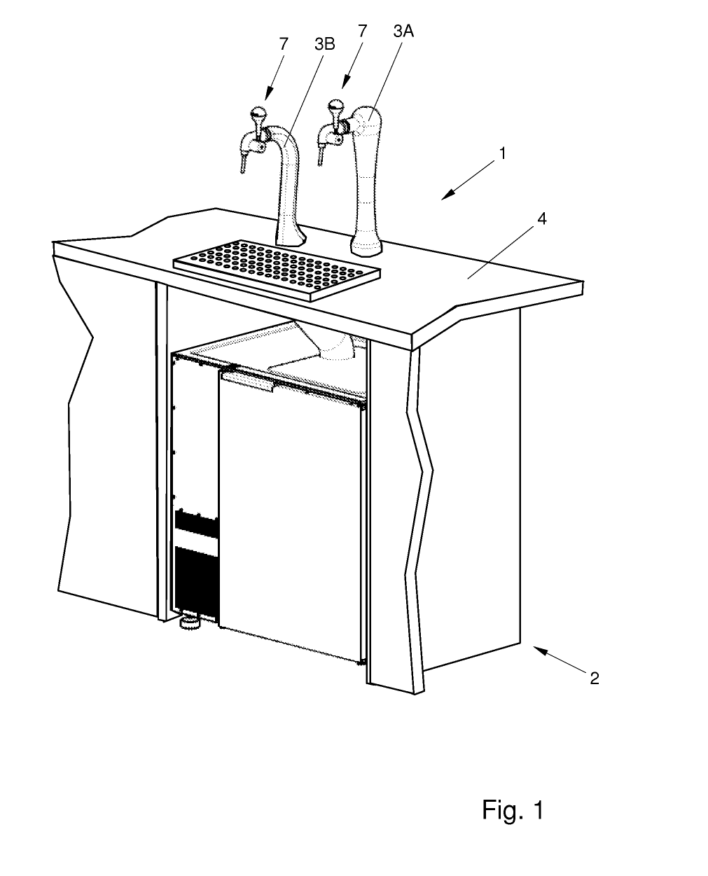

FIG. 1 shows in perspective view a tapping apparatus with two countermounts, built in under a tap counter;

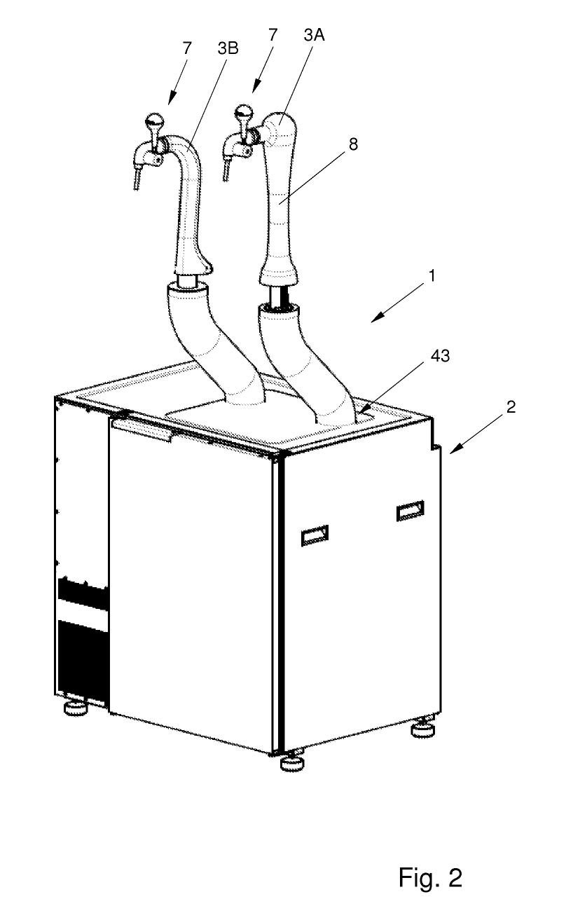

FIG. 2 shows in perspective view a tapping apparatus with two countermounts, without tap counter;

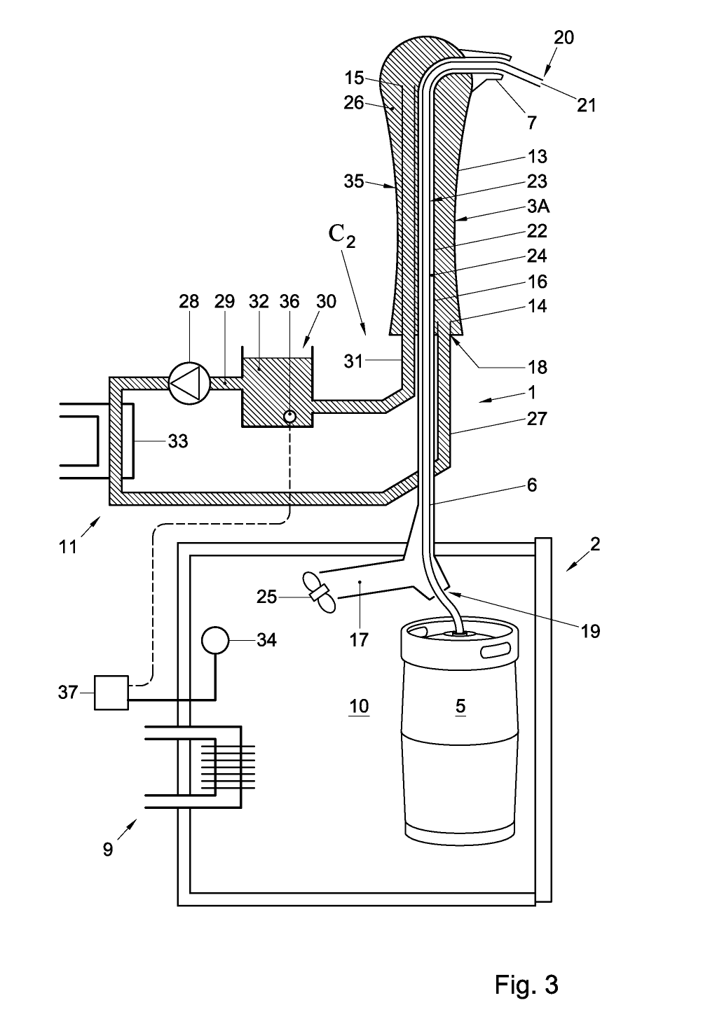

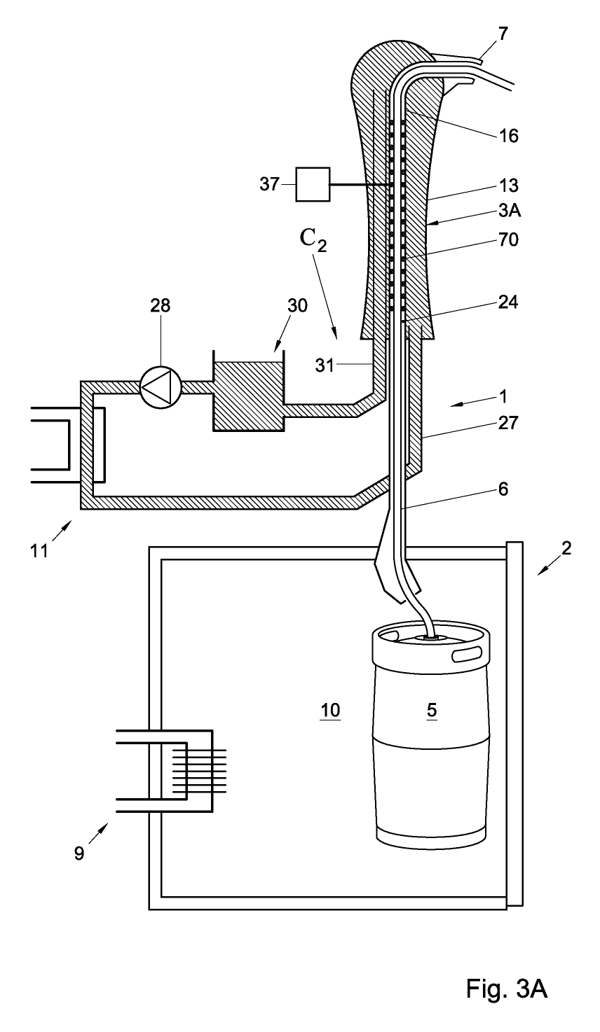

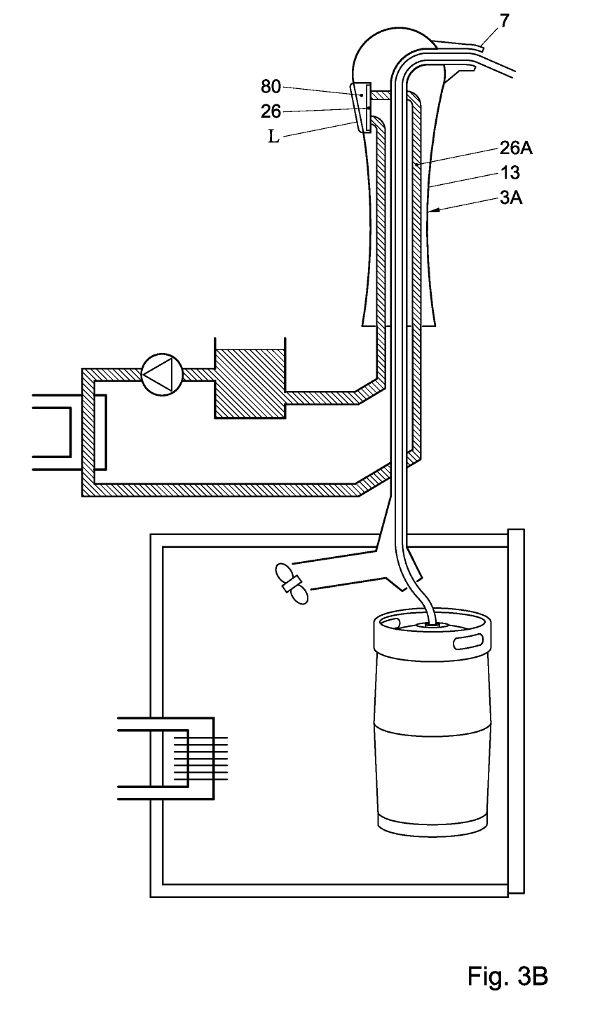

FIG. 3 shows schematically in sectional view a tapping apparatus;

FIGS. 3A and B show a portion of two alternative embodiments of a tapping apparatus;

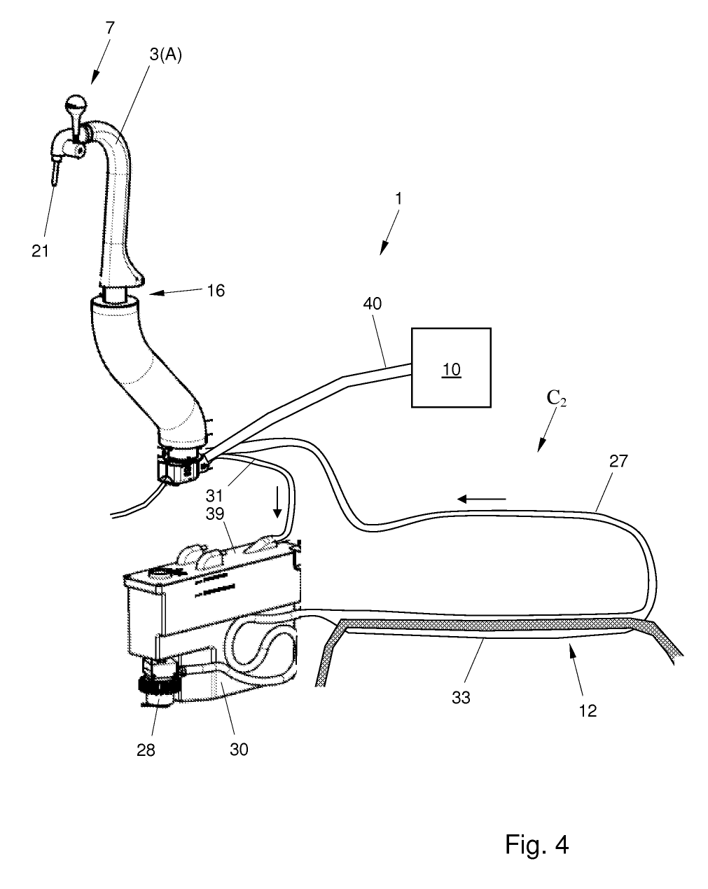

FIG. 4 shows in perspective view a portion of a cooling apparatus, partly sectioned;

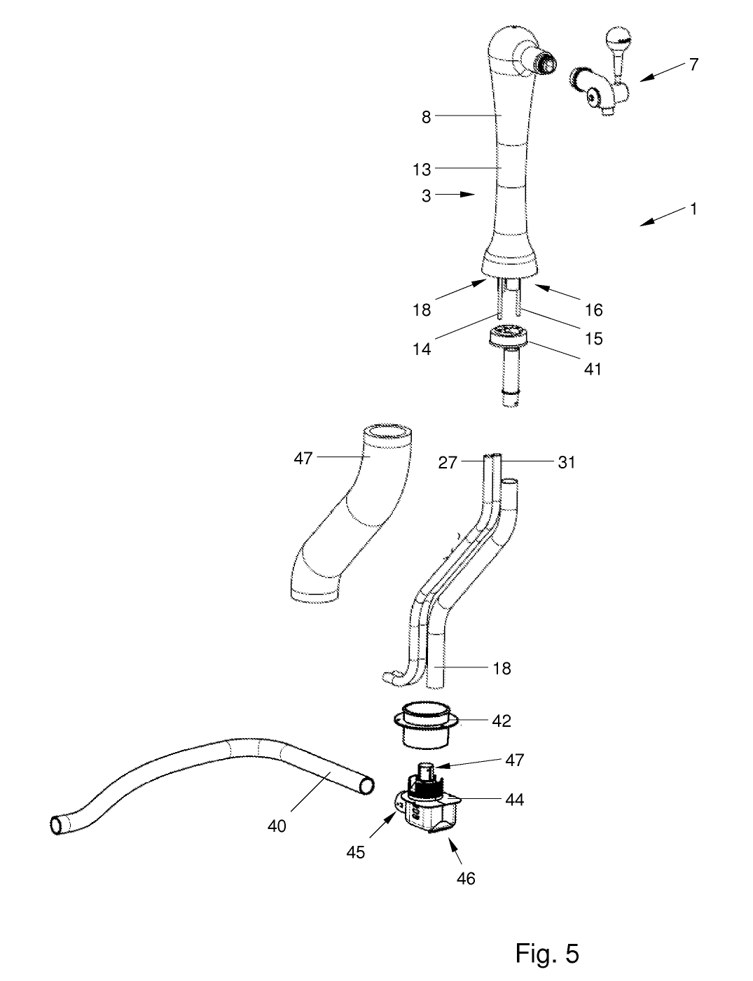

FIG. 5 shows an exploded view of a cooled countermount;

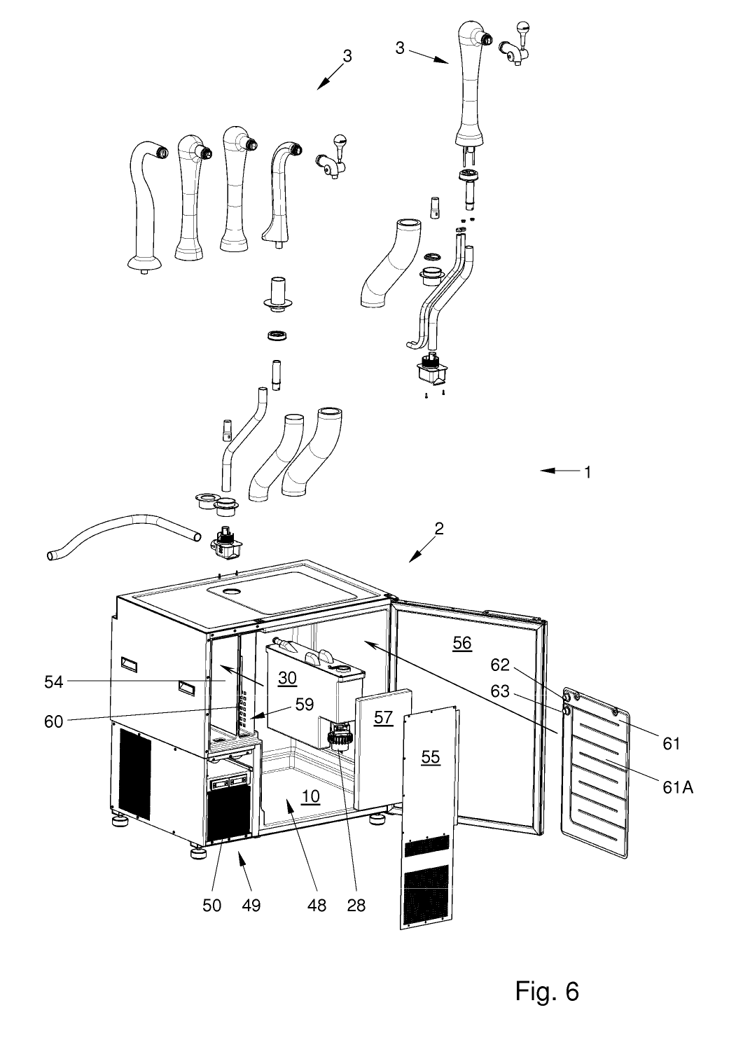

FIG. 6 shows an exploded view of a tapping apparatus with different countermounts;

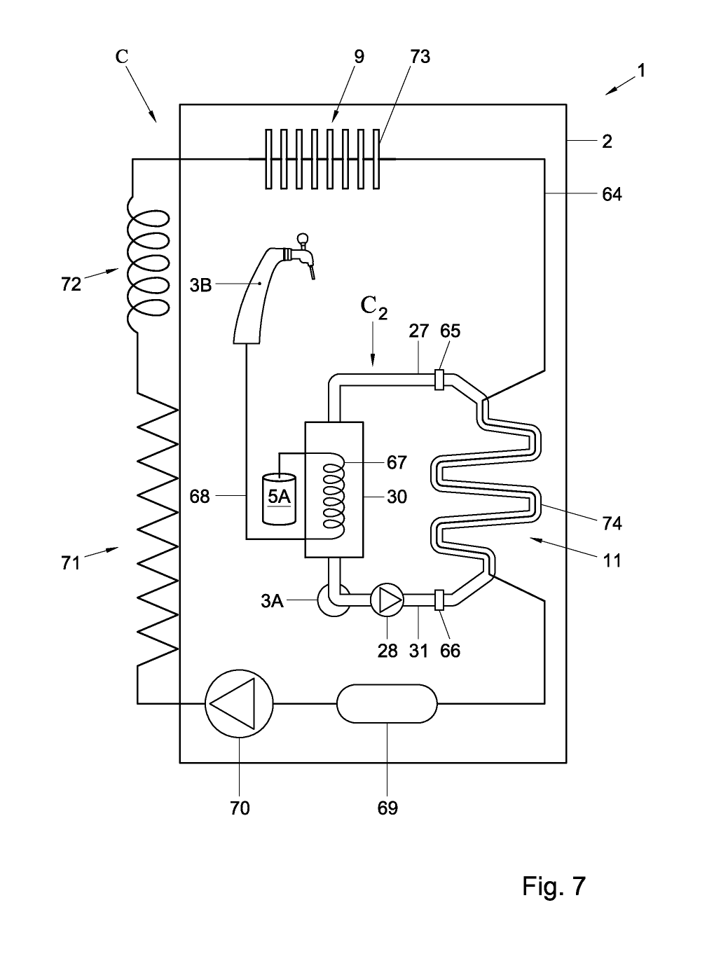

FIGS. 7-9 show three exemplary embodiments of cooling circuits for a tapping apparatus; and

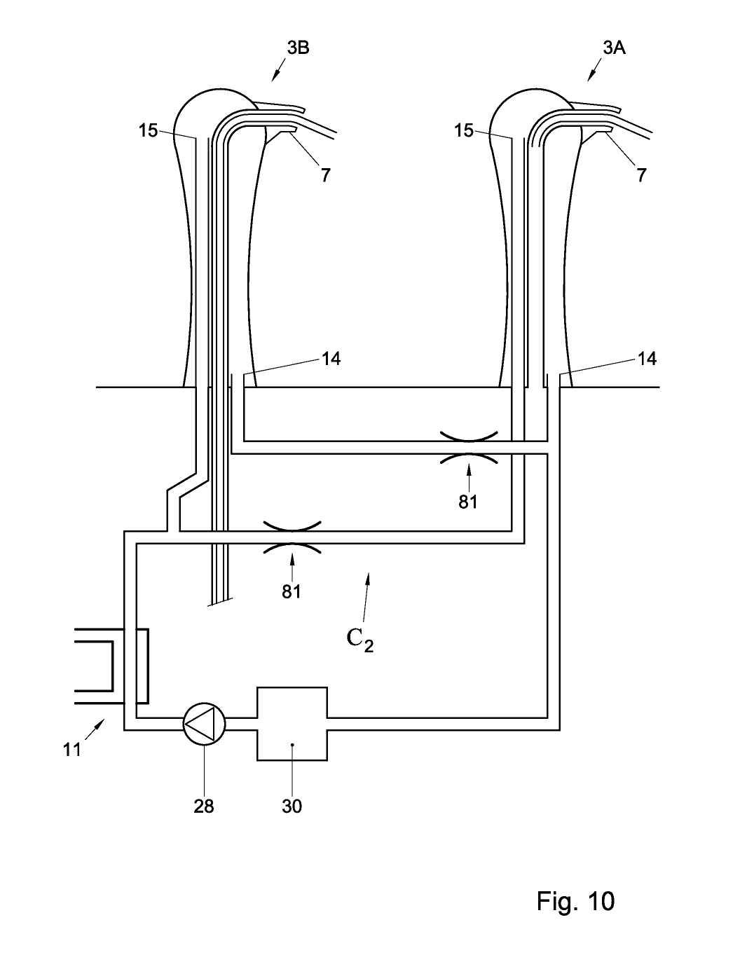

FIG. 10 schematically shows a connection of two cooled countermounts.

In this description, like or corresponding parts have like or corresponding reference numerals. The embodiments shown are shown for illustration only and should not be construed as limiting in any way. Tapping apparatuses and parts thereof can be used for eliminating at least one or more of the disadvantages of the prior art or achieving other advantages or offering an alternative. Also embodiments that do not eliminate the disadvantages of the prior art or do not eliminate all disadvantages of the prior art or do not achieve the advantages contemplated or do not achieve all advantages contemplated, can fall within the invention claimed by the claims.

FIG. 1 shows a tapping apparatus 1 in built-in condition. FIG. 2 shows a tapping apparatus 1 which can be used for that. The tapping apparatus 1 comprises a cooling apparatus 2 having thereon, in the exemplary embodiment shown, two countermounts 3. In the exemplary embodiment shown, for instance the right-hand countermount 3A can be an extra cooled countermount, for instance an iced countermount, and the left-hand countermount 3B a normal cooled countermount. The countermounts 3 may be carried directly on an upper side of the cooling apparatus 2 but may also, for instance, in case of a built-in cooling apparatus 2, be supported at least partly on a tap counter 4 such as a bar. In the cooling apparatus a beverage container 5 (FIG. 3) such as a beer vat, wine cask or the like, or several, the same of different, containers 5 may be set up, which via one or more beverage lines 6 may be connected with one or more of the countermounts 3 or taps 7 arranged thereon. In this way, beverage from the beverage containers 5 can be dispensed with the aid of the taps 7. In this description, extra cooled countermount should be understood to mean at least, though not exclusively, a countermount 3 of which at least a portion is cooled, in particular to a temperature below the freezing point of water and/or condensation. In an embodiment, the cooled countermount may be cooled such that during use, over practically the whole outer surface 8 thereof, an ice layer is formed. In another embodiment, only a portion of the countermount 3 or a portion of an outer surface 8 thereof may be cooled for forming an ice layer. If multiple countermounts 3 are used, extra cooled should be understood to mean at least, though not exclusively, a tapping column 3 which is cooled to a lower temperature than the other, normal countermount 3, based on the lowest outside temperature thereof.

In a tapping apparatus 1 according to this description, preferably two heat exchangers are used, as schematically shown in FIG. 3. A first heat exchanger 9 is provided for cooling a cooling space 10 in which the containers 5 are or can be set up. A second heat exchanger 11 is provided, with which at least the first, extra cooled countermount 3A can be cooled. The first and second heat exchanger 9, 11 can use a same cooling medium, such as air. In the exemplary embodiment shown in FIG. 3, with the first heat exchanger 9 air is cooled, with the second heat exchanger 11 a liquid, for instance glycol or a glycol-containing liquid, is cooled. With the second heat exchanger 11, preferably a different temperature can be regulated than with the first heat exchanger 9, preferably a lower one. In the embodiments shown, the first heat exchanger 9 is a finned heat exchanger, the second heat exchanger 11 a tube-in-tube type heat exchanger. However, also other types of heat exchangers can be used as first and/or second heat exchangers 9, 11.

In the embodiment shown in FIG. 3, a single countermount 3 is shown, which may be designed as an extra cooled countermount 3A or may be operated as such. The countermount 3 comprises a jacket 13, a supply 14 and a discharge 15. A passage 16 is provided within the jacket 13, which extends between an inlet 17 and the tap 7. The inlet 17 may be situated near a lower end 18 of the jacket 13, but the passage 16 may also extend farther than said lower end 18, into the cooling space 10, such that the inlet 17 is provided in the cooling space 10. The passage 16 may be provided with a side inlet 19 through which the beverage line 6 may be introduced into the passage 16, at least during use. However, the beverage line 6 may also be introduced via the inlet 17. The beverage line 6 can be a disposable beverage line, which is replaced, for instance, when changing a container 5, or is changed after a number of containers 5, but may also be provided permanently. Disposable should herein be understood to mean at least, though not exclusively, a beverage line which is so designed that it is thrown away after use. To this end, the beverage line may for instance be of relatively cheap design in plastic, for instance as known from the David® system offered by Heineken®, from the DraughtMaster® system offered by Carlsberg®, the SmartDraft® system offered by Micromatic or as described in EP1289874. The beverage line 6 extends through the passage 16 as far as or into the tap 7. In an embodiment, the tap 7 may be designed as a tap 7 of a known countermount, with the beverage line 6 being connected to an end thereof and the tap 7 having its own shut-off (not shown). Such an embodiment is especially suitable when a (semi)permanent beverage line is used. In another embodiment, the beverage line 6 may be provided with a shut-off (not shown) which can be laid in the tap 7 or can cooperate therewith, as for instance known from the David® system offered by Heineken®, from the DraughtMaster® system offered by Carlsberg®, or the SmartDraft® system offered by Micromatic or as described in EP1289874. In yet another embodiment, the beverage line may be provided with a compressible end 20, which by the tap 7 can be squeezed shut and/or can be opened or whose passage 21 can be released, as for instance known from the PerfectDraft® system offered by Philips® and InBev®. The above-mentioned systems and patent application are mentioned only for illustration and should not be construed as limiting in any way.

In the embodiment shown in FIG. 3, between a wall 22 of the passage 16 and the outside 23 of the beverage line 6 within the passage 16 at least partly a space 24 is provided which, via the inlet 17, is in fluid communication with the cooling space 10. The space 24 can form an air cavity and at least largely prevent direct contact between lines and wall 22. The wall 22 may be thermally insulating. Near the inlet 17 a fan 25 may be provided, which can be driven for passing air from the cooling space 10 into the space 24 and/or drawing air from the space 24 into the cooling space. In this way, the temperature in the space 24 can be regulated and the space 24 can form a temperature regulating space. In another embodiment, the fan 25 is omitted and for feed-through of air through the countermount use is made of natural or forced convection under the influence of pressure differences, which can for instance result from temperature differences between the cooled space 10 and the environment of the tapping apparatus.

Within the jacket 13, around at least a part of the passage 16, in the embodiment shown in FIG. 3, a space 26 is provided, for instance a chamber which is in fluid communication with the supply 14 and the discharge 15. In the embodiment shown in FIG. 3, the supply 14 is arranged low in the space 26 and the discharge 15 high, so that venting of the space 26 is relatively simple. However, this can also be carried out differently or depend on a chosen flow direction of the second cooling fluid. The supply 14 is connected via a first line 27 which extends through the second heat exchanger 11 as far as a delivery side of a pump 28. The suction side of the pump 28 is connected via a second line 29 with a vat 30, which vat 30 is connected via a line 31 with the discharge 15. The lines 27, 29, 31, the space 26, the pump 28 and the vat 30 form a second cooling circuit C₂ and are filled with the second cooling medium, for instance glycol 32, which can be pumped round with the aid of the pump 28. Between the delivery side of the pump 28 and the supply 14, around the first line 27 a portion 33 of the second heat exchanger 11 is arranged, through which during use refrigerant can be passed, for cooling the second cooling medium.

During use, beverage is passed via the beverage line 6 to the tap 7, to be dispensed thereby. In the cooling space 10, the temperature is measured with the aid of a first temperature sensor 34. If the temperature rises above a desired temperature, the first heat exchanger 9 will come into operation to supply cold to the cooling space 10 and thereby re-adjust the temperature below the desired temperature mentioned. With the aid of the second heat exchanger 11, the second cooling medium is cooled and pumped through the second cooling space C₂ by the pump 28. Within the jacket 13 cold is thereby exchanged with at least the outer wall 35 of the jacket 13 or a part thereof, such that on the outer side of the jacket 13 condensation freezes and an ice layer forms. A second temperature sensor 36, for instance in the vat 30, will measure the temperature of the second cooling medium 32 returned. From this, with the aid of a control device 37, it can be determined how much heat has been supplied to the second cooling medium 32 in the jacket 13, on the basis of which the temperature of the second cooling medium 32 can be regulated and adjusted with the aid of the second heat exchanger 11.

The temperature of the second cooling medium 32 will be considerably lower than that of the first cooling medium with which the cooling space 10 is cooled and/or the temperature of the cooling space 10 and in particular containers 5 present therein and beverage received therein will be considerably higher than that of the second cooling medium 32 in the space 26. By passing air, with the aid of the fan 25, through the space 24 along at least a part of the beverage line 6 within the jacket, regulation is enabled so that the temperature of the beverage line 6, or at least beverage therein, is kept above the freezing point of the beverage, also when the beverage stands still in the respective part of the beverage line 6, while the temperature of the second cooling medium 32 and in particular of the jacket 13 can be kept (considerably) lower. Without wishing to be bound by any theory, it seems the air is used for at least partly heating the beverage line 6, so that the beverage is prevented from freezing, while the jacket 13 and in particular the outer wall, in whole or parts thereof, can be cooled such that ice formation can occur thereon and/or an ice layer formed thereon can be maintained. Incidentally, in a more general sense, as a result, a temperature difference between the cooling space 10, the beverage line 6 within the jacket 13 and the jacket 13 and/or the outer wall thereof can be achieved.

FIG. 4 shows schematically in perspective view a portion of a cooling apparatus with countermount 3, in particular an extra cooled countermount 3A, and a portion of the cooling space C₂. The pump 28 is here provided directly at an underside of the vat 30, which vat 30 has a closed cover 39. The vat 30 constitutes a buffer, so that the temperature regulation is sufficiently constant and reliable and there is a sufficient cooling capacity. A line 40 is shown, which extends from the cooling space 10 as far as the passage 16 and can bring air from the cooling space 10 into the passage 16 or can discharge air therefrom to the cooling space 10. Actually, this air line 40 forms a part of the passage 16 as shown in FIG. 3.

FIG. 5 shows in exploded view a portion of the tapping apparatus 1, especially the countermount 3 and a part of the lines for connection thereof. The countermount 3 with the jacket 13 is provided, at a lower end 18, with connections for the passage 16 and the supply 14 and discharge 15. A first connector 41 is provided for cooperation with the connections of the countermount 3. A second connector 42 is provided which can fit into an opening 43 in the upper side of the cooling space 10, which is for instance formed by or is included in a refrigerator. A connecting box 44 is provided at the underside of the second connector 42. The connecting box 44 is provided with a first opening 45 for connection of the air line 40 and a second opening 46 for feed-in and/or feed-through of the at least one beverage line 6 (not shown in FIG. 5). At the top side, the connecting box 44 is provided with a connection for a feed-through tube 46 which forms part of or can link up with the passage 16, via the first connector 41. The first line 27 and third line 31 have been guided alongside the feed-through tube 46. An insulation tube 47 may be arranged around the feed-through tube 46 and the two lines 27 and 31. In the example shown, the feed-through tube 46 and the lines 27, 31 are slightly bent, in particular slightly S-shaped. As a result, the countermount 3 can be arranged in displaced relation with respect to the opening 43 and a greater freedom is obtained for placement thereof on a tap counter. In an embodiment, the feed-through tube 46 and the lines 27, 31 can be slightly flexible, for a still greater freedom of placement.

FIG. 6 shows an exploded view of an embodiment of a tapping apparatus 1, with different countermounts 3 that can be used therewith. In this embodiment, the cooling apparatus is provided with at least three compartments. A first compartment 48 constitutes the cooling space 10. A second compartment 49 comprises technical elements 50 of the cooling apparatus, in particular at least a compressor, a condenser and a fan. Additionally, electronic elements such as the control device 37 may be provided therein. The third compartment 54 can comprise at least the vat 31, with the pump 28. The second compartment 49 and third compartment 54 are arranged one above the other and may be closed off by a plate 55. The first compartment 48 can in addition be provided with and be closable with a door 56. The third compartment 54 is preferably thermally insulated, for instance inter alia through a plate 57. In the partition wall 59 between the first compartment 48 and the second compartment 49, an opening 60 may be provided for passing air cooled by the first heat exchanger 9 to the cooling space 10. Optionally, the partition wall 59 can function as evaporator of the first heat exchanger 9. In the cooling space 10 a cooling element 61 may be provided, in which for instance water or beverage can be cooled. The cooling element 61 can for instance comprise a line or channel between an input 62 and an output 63, to which lines (not shown) can be connected, which can extend to outside the cooling space. Water can thereby be passed into the cooling element 61, can therein be cooled through heat exchange with the air and/or a wall in the cooling space 10, and thereupon be delivered again. In an alternative embodiment, the cooling element may also be designed differently, for instance as a bag, vat, cask or the like. The cooling element 61 is preferably not placed against the coldest wall of the cooling space 10, in order to prevent freezing thereof. More particularly, it is advantageous to place the cooling element 61 against a least cold wall, for instance the wall opposite the partition wall or at least opposite an entrance of cooled air.

In an embodiment represented in FIG. 3A, around a part of the beverage line 6 within a countermount 3, for instance the extra cooled countermount 3A, a heating element 70 is arranged, connected to the control device 37. With this, heat can be supplied to the beverage line, and hence to beverage therein, when the temperature of the beverage line and/or the beverage falls below a desired temperature. Such a temperature fall can for instance be determined on the basis of the change in temperature of cooling medium in the first and/or second heat exchanger 9, 11, in the cooling space 10 and/or through direct measurement of the temperature of the beverage line 6. Such regulations will be immediately clear to those skilled in the art.

In FIG. 3B, a further alternative embodiment is shown, wherein the circuit C2 extends substantially as a line 26A through the countermount 3B, while a limited space or chamber 26 may be provided. Against a wall of that chamber or directly against the line 26A, a side of for instance a thermoelectric element such as a Peltier element 80 or similar active cooling element may be arranged, while the opposite side of the Peltier element is arranged, for instance, against a side of the wall of the jacket 13. An element to be cooled, as for instance a logo L, may be arranged against it. Since in this way a greater temperature difference ΔT is obtained between element L to be cooled and the heat emitting side of the Peltier element 80, in an energetically effective manner a strong cooling of the element L is obtained, for instance for freezing it. Moreover, with this, in a simple manner a partial freezing can be obtained.

FIG. 7 shows an embodiment of a cooling circuit C, or at least a refrigerant-side part thereof. Clearly visible in this cooling circuit C are the first heat exchanger 9 and the second heat exchanger 11, series-connected and coupled via a line section 64. Coupled to the second heat exchanger 11 are the vat 30 and the pump 28. The countermount 3A is drawn-in only schematically, in the form of a circle. In the first line 27 and the third line 31, respectively, a first coupling 65 and a second coupling 66 is arranged, for coupling of the circuit C₂ with the heat exchanger 11. As a result, the circuit C₂ can be uncoupled and, for instance, be omitted if no extra cooled countermount 3A is used, or if a different object to be cooled is to be linked up. Thus, the tapping apparatus can be flexibly built up and, if desired, be configured differently in the course of time. In FIG. 7 there is included in the vat 30 a cooling coil 67, which is connected with or integrated in a line 68 which can extend from a beverage container 5A into a countermount 3, in particular a normal countermount 3B.

The circuit C is accommodated partly in the cooling apparatus 2 and partly outside the cooling apparatus 2 or in open communication with the atmosphere outside the cooling apparatus 2. The circuit C comprises an accumulator 69 and a compressor 70. Moreover, a condenser 71 and a capillary 72 are included. Of the first heat exchanger 9 an evaporator 73 is included in the circuit C, and of the second heat exchanger an evaporator 74. It is clearly visible that for the two heat exchangers 9, 11, only one compressor 70, one accumulator 69, one condenser 71 and one capillary 72 are included. This makes the apparatus relatively simple and little costly. The compressor 70 can be of modulating design, so that it can be controlled on the basis of, for instance, the cold demand in the cooling space, for which the first heat exchanger 9 may be provided, and/or the cold demand of the second heat exchanger and/or an object to be cooled, such as the countermount 3A, 3B, connected thereto.

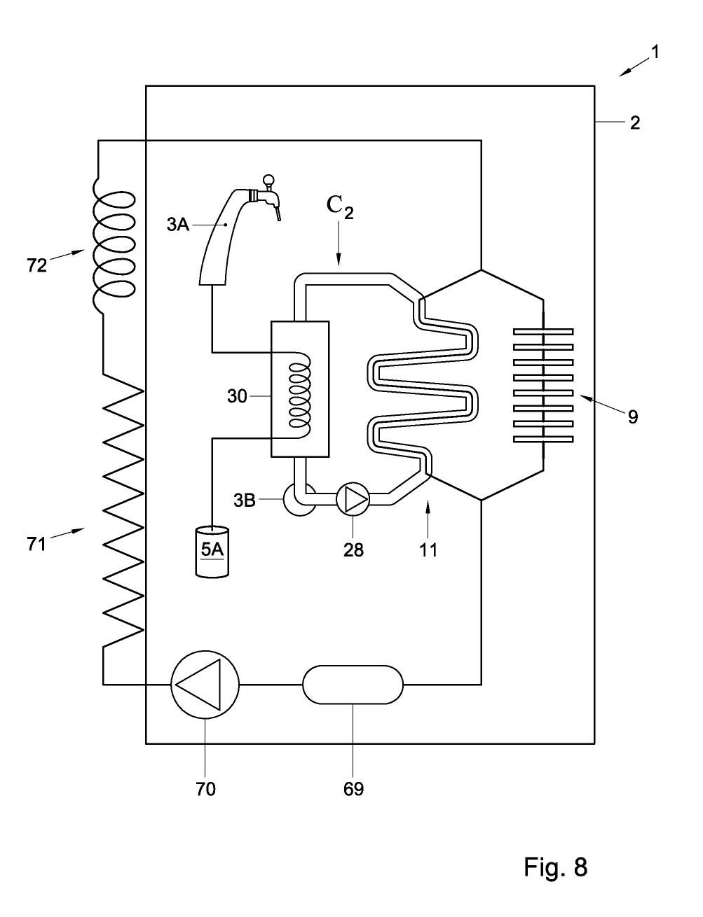

In FIG. 8 a cooling circuit C is shown, where the first heat exchanger 9 and the second heat exchanger 11 are connected in parallel between the capillary 72 and the accumulator 69. Here, the first 9 and the second heat exchanger 11 can be jointly driven. The refrigerant (coolant) in the cooling circuit C will be divided over the first heat exchanger 9 and the second heat exchanger 11, for instance on the basis of the flow resistance of the evaporators 73, 74 of the two heat exchangers 9, 11. In an embodiment not shown, a regulating valve may be included, in flow direction before or behind at least one of the two heat exchangers 9, 11 and preferably before or behind both heat exchangers 9, 11, so that the division of the refrigerant over the two heat exchangers can be controlled, for instance on the basis of the cold demand of the two heat exchangers 9, 11. To this end, for instance a valve controlled by a temperature sensor can be used. Such a sensor can for instance be included in the cooling space 10 and/or in or at the countermount 3A, 3B and/or in or at the vat 30. Moreover, the compressor 70 can be controlled on the basis of the temperatures.

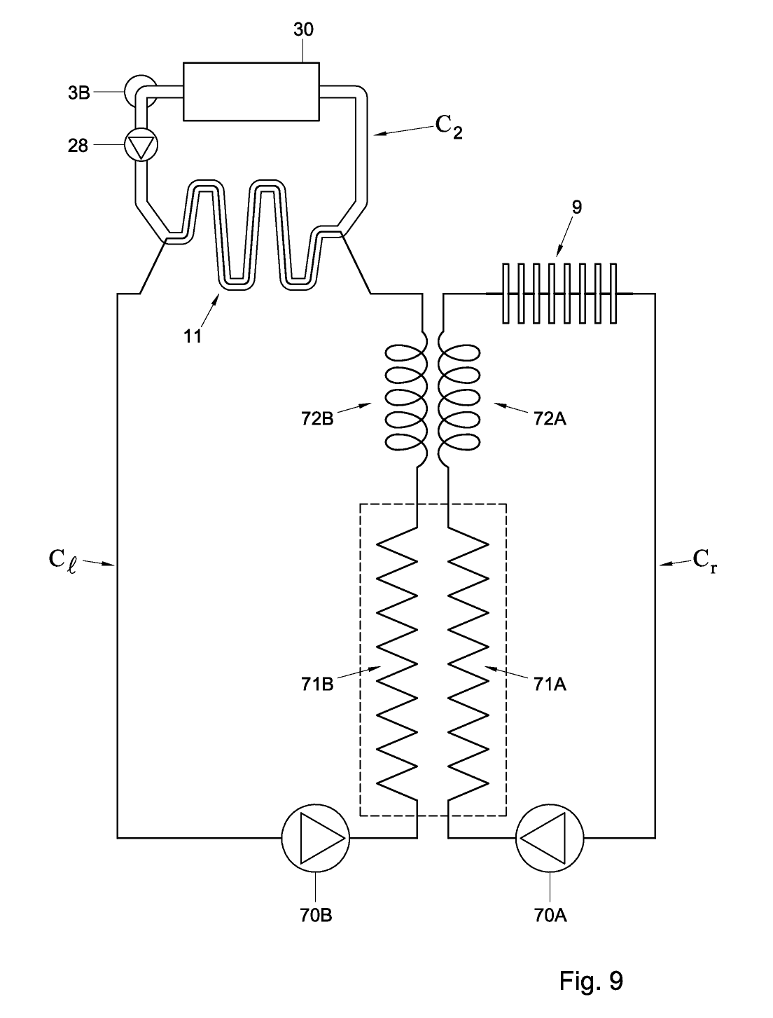

In FIG. 9 a further embodiment of a part of a cooling apparatus with a cooling circuit C is shown, where two separate circuits C₁, Cᵣ are shown. In the partial circuit Cᵣ shown on the right-hand side in FIG. 9, a first compressor 70A, a first condenser 71A, a first capillary 72A and the evaporator 73 of the first heat exchanger 9 are included. In the partial circuit C₁ shown on the left-hand side, a second compressor 70B, a second condenser 71B, a second capillary 72B and the evaporator 74 of the second heat exchanger 11 are included. In an embodiment, the first and second condenser 71A, B may be accommodated in a housing or be combined as one condenser. In an embodiment with two compressors, the advantage can be achieved that the two partial circuits C₁, Cᵣ can be controlled at least partly and preferably wholly independently of each other, while the control is relatively simple and may be arranged on the basis of separate temperature sensors for the two partial circuits.

In FIG. 10 schematically two countermounts 3A, 3B are shown, coupled to the same cooling circuit, for instance the cooling circuit C₂ of the second heat exchanger. Here, the two countermounts 3A, 3B are connected to the buffer vat, while a division over the two countermounts is provided. A throttle device 81 is included in flow direction before and/or after one of the countermounts 3A, so that a preselected division of the cooling liquid over the two countermounts 3 can be obtained and hence cooling thereof. In an alternative embodiment, the two countermounts 3A, 3B may be included in series in the circuit C₂. Here, preferably, the extra cooled countermount 3A is included in flow direction of the cooling liquid before the other countermount 3B. The countermounts 3A, 3B may for instance be laid out such that on the jacket, or a part thereof, of the first countermount 3A, ice formation occurs, whereas the second countermount 3B, or at least a beverage line extending therethrough, is only cooled without freezing occurring. Optionally, to that end, a throttle device may also be provided between the countermounts 3A, B.

The invention is not limited in any way to the embodiments shown and described in the description and drawings. Many variations thereon are possible within the framework of the inventions outlined by the claims. These include at least all combinations of the embodiments shown and parts thereof. Further, multiple countermounts and other objects to be cooled can be used in a tapping apparatus according to the description, while moreover multiple heat exchangers may be provided. The cooling circuits may be adapted and laid out in a known manner, depending on the specific layout of the tapping apparatus. Also, other tapping means may be used. For instance, the second heat exchanger 11 may be designed as a tube-in-tube heat exchanger, with three tubes included within each other, where for instance between two of the tubes, as the central tube and outer tube, a beverage may be cooled, while between the central tube and the inner tube a coolant such as glycol may be guided, for cooling of the countermount 3B.

These and many comparable and other variations are understood to fall within the framework of the invention outlined by the claims.

1. A countermount, provided with a jacket and a passage, wherein the jacket is provided with a supply and a discharge for a cooling fluid and the passage extends between an inlet and a tap, wherein within the passage a beverage line is provided which extends at least between the inlet and the tap, wherein between at least a part of a wall of the passage and the beverage line, a temperature regulating space and/or a temperature regulating element is provided.

2. A countermount according to claim 1, wherein the inlet is in fluid communication with an air regulator for feeding air into or out of the temperature regulating space.

3. A countermount according to claim 1, wherein between at least a part of the jacket and the wall of the passage a space is provided, in fluid communication with the supply and the discharge, arranged for receiving and passing-through the cooling fluid.

4. A tapping apparatus provided with a cooling space and a countermount, wherein through the countermount a beverage line extends, from the cooling space to at least near a tap near an end of the countermount remote from the cooling space, wherein within the countermount along at least a part of the beverage line a space extends, which space is or can be brought in fluid communication with an inner space of the cooling space, wherein the countermount is provided with a supply and a discharge for a cooling medium for cooling of at least a part of an outer side of the countermount.

5. A tapping apparatus according to claim 4, wherein an air displacer is provided for forcing air from the inner space into the space or from the space into the inner space.

6. A tapping apparatus according to claim 4, wherein the cooling space is connected to a cooling circuit, which cooling circuit comprises a first heat exchanger.

7. A tapping apparatus according to claim 4, wherein to the supply and discharge a cooling circuit is connected, filled with a cooling medium such as glycol, which cooling circuit comprises a second heat exchanger.

8. A tapping apparatus according to claim 6, wherein to the supply and discharge a cooling circuit is connected, filled with a cooling medium such as glycol, which cooling circuit comprises a second heat exchanger, and wherein the first heat exchanger is arranged for cooling of gas, in particular air, and the second heat exchanger is arranged for cooling of a cooling liquid, in particular glycol.

9. A tapping apparatus according to claim 6, wherein to the supply and discharge a cooling circuit is connected, filled with a cooling medium such as glycol, which cooling circuit comprises a second heat exchanger, and wherein at least the second heat exchanger is a tube-in-tube type heat exchanger or wherein the first and second heat exchanger are integrated as a tube-in-tube-in-tube heat exchanger.

10. A tapping apparatus according to claim 4, wherein the beverage line is an exchangeable beverage line, in particular a disposable.

11. A tapping apparatus according to claim 4, wherein at least a part of the beverage line situated near or in the tap is situated outside a part of the countermount cooled by the cooling medium.

12. A tapping apparatus according to claim 4, wherein at least a first heat exchanger is placed in the cooling space, such that air cooled by the first heat exchanger can be passed from the cooling space alongside the beverage line.

13. A tapping apparatus according to claim 4, wherein a regulating device is provided for regulating the temperature of the beverage line and/or beverage present in the beverage line within the countermount, through regulation of air flow within the space in the countermount around the beverage line.

14. A tapping apparatus according to claim 4, wherein a thermoelectric element is coupled with or attached near or against a line or space connected to the supply and discharge, in particular with a side emitting heat during use.

15. A method for regulating the temperature of beverage in a beverage line which extends through a countermount, wherein around at least a part of the beverage line within the countermount a fluid flow is effected which is supplied from the environment of the countermount and/or from a cooling space and wherein at least a part of the countermount is cooled with a cooling medium other than the fluid flow, in particular to a temperature lower than that of the fluid flow.

16. A method according to claim 15, wherein the fluid flow is cooled with the aid of a first heat exchanger and the countermount with the aid of a cooling medium which is cooled with the aid of a second heat exchanger.

17. A method according to claim 15, wherein the first and the second heat exchanger are connected to or provided in a cooling circuit with a joint compressor and/or condenser.
